(19) United States
(12) Patent Application Publication
(10) Pub. No.: US 2008/0138628 A1
(43) Pub. Date: Jun. 12, 2008

(54) Reducing particle generation as a result of metal to metal contact during the manufacturing process

(76) Inventors: Yi Zhao Yao, Singapore (SG); Sai H. Wong, Singapore (SG); Jirou Kaneko, Odawara-shi (JP)

Correspondence Address: HITACHI C/O WAGNER BLECHER LLP, 123 WESTRIDGE DRIVE, WATSONVILLE, CA, 95076, US

(21) Appl. No.: 11/636,123

(22) Filed: Dec. 8, 2006

(51) Int. Cl. B32B 15/08; B05D 3/10

(52) U.S. Cl. 428/418; 427/327

(57) ABSTRACT

Embodiments of the present invention pertain to reducing particle generation as a result of metal to metal contact during the manufacturing process. According to one embodiment, a metal component that will be used in manufacturing a hard disk drive is cleaned. The metal component is coated with a substance to reduce a probability that the metal component will come into contact with other metal during the manufacturing of the hard disk drive, wherein the coating of the substance encapsulates the metal component and provides lubrication between the metal component and the other metal.

### TECHNICAL FIELD

Embodiments of the present invention relate to manufacturing. More specifically, embodiments of the present invention relate to reducing particle generation as a result of metal to metal contact during the manufacturing process.

### BACKGROUND

Manufacturing disk drives is a very competitive business. People that buy disk drives are demanding more and more for their money. For example, they want disk drives that are more reliable and have more capabilities but cost less. One way to provide more capabilities is to make the various disk drive components smaller.

Particles in disk drives can cause damage to the disk drives. One source of particles is the manufacturing tools that are used to manufacture the disk drives. In order to minimize particles that come from the manufacturing tools, the manufacturing tools are typically deep cleaned about once a week. Deep cleaning the manufacturing tools requires halting manufacturing. Many of the manufacturing tools are lapped as a part of deep cleaning them. Typically manufacturing is halted for approximately 4-8 hours while the manufacturing tools are deep cleaned.

### SUMMARY OF THE INVENTION

Embodiments of the present invention pertain to reducing particle generation as a result of metal to metal contact during the manufacturing process. According to one embodiment, a metal component that will be used in manufacturing a hard disk drive is cleaned. The metal component is coated with a substance to reduce a probability that the metal component will come into contact with other metal during the manufacturing of the hard disk drive, wherein the coating of the substance encapsulates the metal component and provides lubrication between the metal component and the other metal.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a plan view of a disk drive for facilitating the discussion of various embodiments of the present invention.

FIG. 2 depicts block diagrams of a balanced weight in relation to other entities.

FIGS. 3A-3E depict diagrams of a C-hand moving a conventional balanced weight around.

FIG. 4 depicts a coated metal component, according to one embodiment.

FIG. 5 depicts a bar chart of particles generated at various phases of a conventional manufacturing process using a conventional uncoated balanced weight, according to one embodiment.

FIG. 6 depicts a bar chart comparing the number of particles generated using a conventional balanced weight and using a balanced weight that was coated using various embodiments.

FIG. 7 depicts a flowchart of a method for reducing particle generation as a result of metal to metal contact during the manufacturing process, according to various embodiments.

The drawings referred to in this description should not be understood as being drawn to scale except if specifically noted.

### DETAILED DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

Various metal tools are used in manufacturing disk drives. The tools typically include metal. Further, various disk drive components may also include metal (referred to hereinafter as “metal components.”) During the manufacturing process, metal frequently comes into contact with other metal, which results in the generation of particles. For example, the metal tools come into contact with metal components or metal components come into contact with each other. Another source of particles is the particles that result from lapping the tools as a part of deep cleaning.

As already stated, particles can damage disk drives, therefore, it is important to reduce the number of particles generated during the manufacturing process. According to one embodiment, particle generation as a result of metal to metal contact during the manufacturing process is reduced by coating a metal component with a substance that encapsulates the metal component and provides lubrication between the metal component and other metal. The other metal may be from metal components or from metal tools, among other things. By coating the metal component, the metal tools will no longer be lapped. Thus, coating the metal component reduces and possibly even eliminates the particles generated from lapping metal manufacturing tools. Further, it is important to reduce the amount of time that it takes to manufacture disk drives. Coating metal components significantly reduces and possibly even eliminates the halting of the manufacturing process that results from conventional cleaning of metal tools which provides a significant financial savings to manufacturers of disk drives.

### Hard Disk Drive

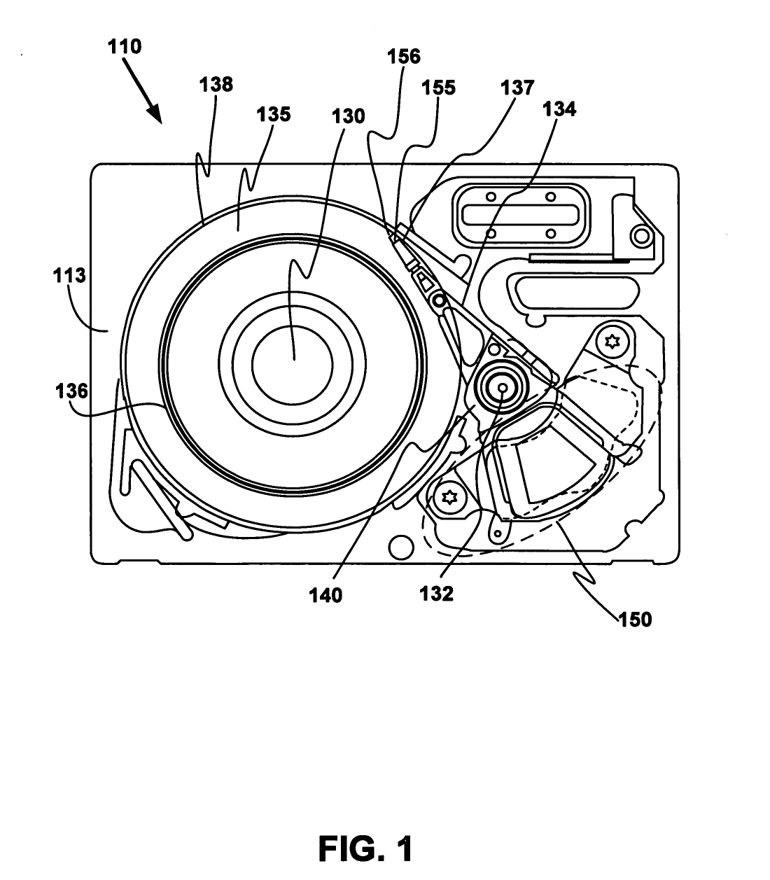

FIG. 1 depicts a plan view of a disk drive for facilitating the discussion of various embodiments of the present invention. The disk drive 110 includes a base casting 113, a motor hub assembly 130, a disk 138, actuator shaft 132, actuator arm 134, suspension assembly 137, a hub 140, voice coil motor 150, a magnetic head 156, and a slider 155.

The components are assembled into a base casting 113, which provides attachment and registration points for components and sub assemblies. A plurality of suspension assemblies 137 (one shown) can be attached to the actuator arms 134 (one shown) in the form of a comb. A plurality of transducer heads or sliders 155 (one shown) can be attached respectively to the suspension assemblies 137. Sliders 155 are located proximate to the disk 138's surface 135 for reading and writing data with magnetic heads 156 (one shown). The rotary voice coil motor 150 rotates actuator arms 135 about the actuator shaft 132 in order to move the suspension assemblies 150 to the desired radial position on a disk 138. The actuator shaft 132, hub 140, actuator arms 134, and voice coil motor 150 may be referred to collectively as a rotary actuator assembly.

Data is recorded onto the disk's surface 135 in a pattern of concentric rings known as data tracks 136. The disk's surface 135 is spun at high speed by means of a motor-hub assembly 130. Data tracks 136 are recorded onto spinning disk surfaces 135 by means of magnetic heads 156, which typically reside at the end of sliders 155.

FIG. 1 being a plan view shows only one head, slider and disk surface combination. One skilled in the art understands that what is described for one head-disk combination applies to multiple head-disk combinations, such as disk stacks (not shown). However, for purposes of brevity and clarity, FIG. 10 only shows one head and one disk surface.

### Conventional Metal Components and the Conventional Manufacturing Process Using Conventional Metal Components

Examples of conventional metal tools include the various tools that can be used to manufacture a hard disk drive. The tools include jigs. Examples of conventional metal components include balanced weights, various parts of disk packs, and various metal components depicted in FIG. 1, among other things. Many of the embodiments of the present invention shall refer to a balanced weight, which is used to balance a disk pack so that, among other things, the disks rotate properly.

The balanced weight is opened and picked up from the stainless steel stand. Then the balanced weight is positioned over the disk pack and inserted into a groove of a top clamp associated with the disk pack. The balanced weight is slid into the groove. As will become more evident, the processes of opening, picking up, inserting, among other things, result in metal to metal contact and the generation of particles.

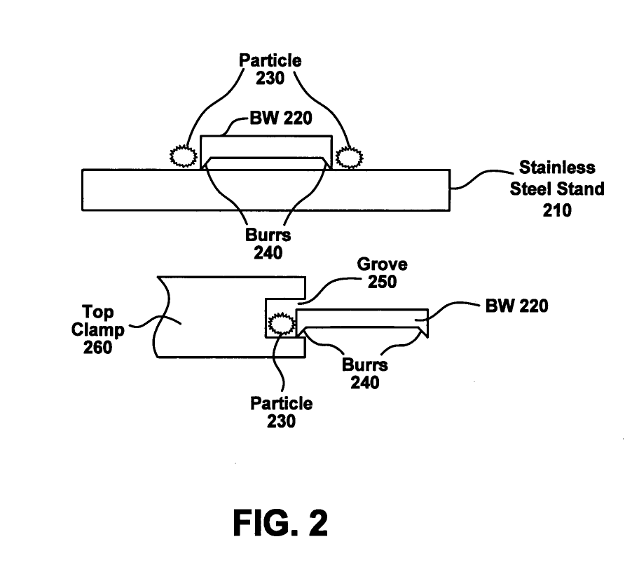

FIG. 2 depicts block diagrams of a balanced weight in relation to other entities. On the top, the balanced weight 220 is depicted on a stainless steel stand 210. The metal of the balanced weight 220 comes into contact with the metal of the stainless steel stand 210 resulting in the generation of particles 230. Further, the balanced weight 220 may have projections 240 (also known as “burrs”) that resulted from the supplier of the balanced weight 220 stamping the balanced weight 220. The burrs 240 can cause additional friction resulting in even more particles 230 being generated. On the bottom, FIG. 2 depicts the balanced weight after it has been inserted into the groove of a top clamp. The metal of the balanced weight 220 comes into contact with the metal of the groove 250 associated with the top clamp 260 resulting in the generation of particles 230.

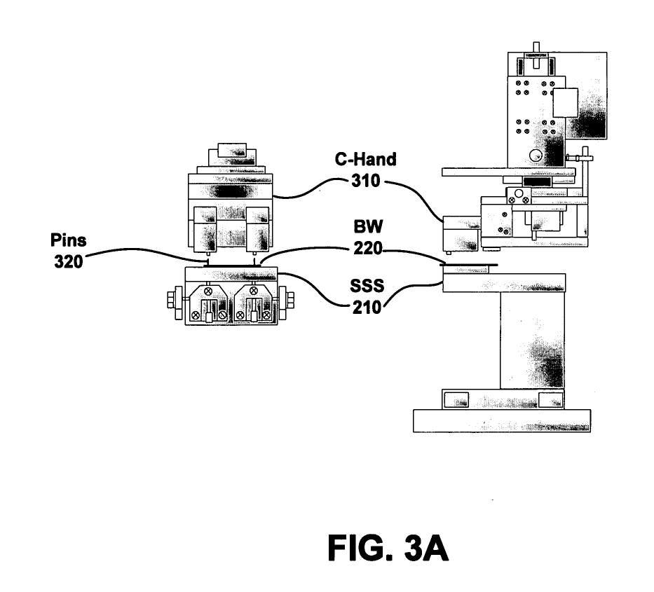

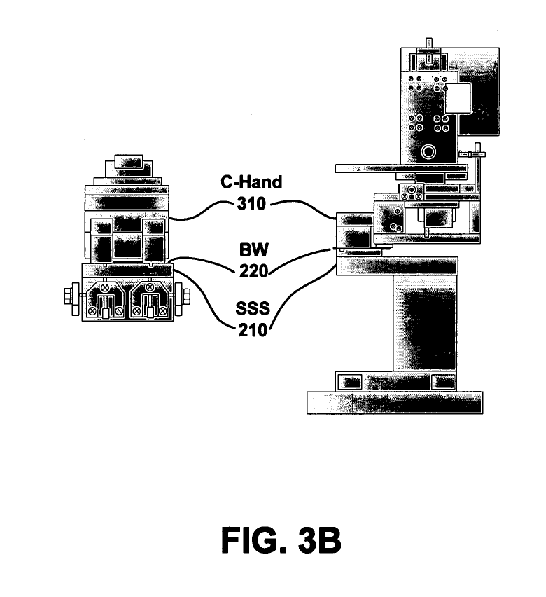

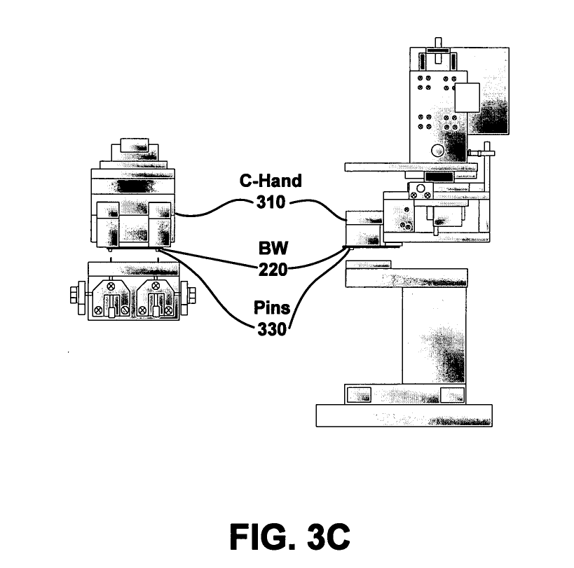

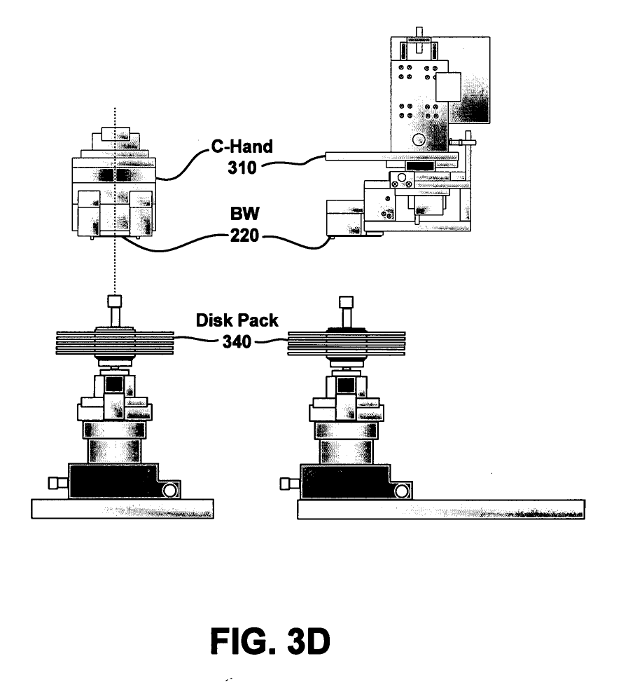

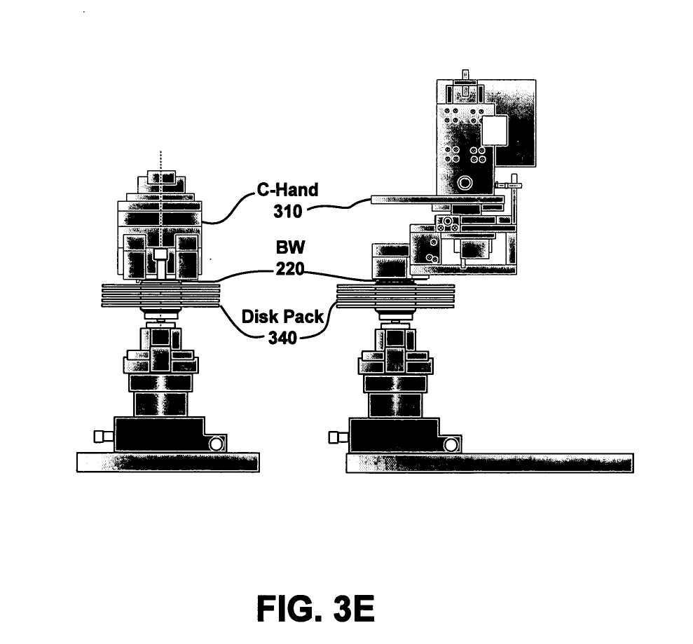

Frequently, what is known as a C-hand is used to move the balanced weight around. For example, the C-hand can be used to pick a balanced weight up off of the stainless steel stand, position it over a disk pack, and insert it into the groove of a top clamp to balance a disk pack. FIGS. 3A-3E depict diagrams of a C-hand 310 moving a conventional balanced weight 220 around. FIG. 3A depicts the C-hand 310 as it is positioned over the balanced weight 220 preparing to pick the balanced weight 220 up off of the stainless steel stand 210. The balanced weight 220 has holes in it that pins 320 can be inserted into to hold the balanced weight 220 in place. The metal of the pins 320 comes into contact with the metal of the balanced weight 220 resulting in the generation of particles.

FIG. 3B depicts the C-hand 310 coming down on top of the balanced weight 220 in order to pick it up. The metal of the C-hand 310 comes into contact with the metal of the balanced weight 220 resulting in the generation of more particles. In FIG. 3C, the C-hand 310 picks the balanced weight 220 up. The C-hand 310 uses seal pins 330 that go through the balanced weight 220's holes as a part of picking the balanced weight 220 up, which results in more particles being generated. In FIG. 3D, the C-hand 310 positions the balanced weight 220 over a HDD's disk pack 340. In FIG. 3E, the C-hand 310 lowers the balanced weight 220 and inserts the balanced weight 220 into the groove 250 of the disk pack 340's top clamp. Inserting the balanced weight 220 into the groove 250 causes metal to metal contact resulting in the generation of more particles.

### Particles

Particles 230 may be generated due to metal to metal contact. Examples of materials that the particles may be made of include but are not limited to silicon carbide (SiC), alumina (Al₂O₃), stainless steel (SS) 300, and stainless steel 400. A balanced weight typically includes SS 300 and the groove that the balanced weight is inserted into typically includes SS 400.

SiC and Al₂O₃ are typically generated during the lapping of metal manufacturing tools. For example, SiC and Al₂O₃ materials are frequently used for lapping and burnishing during conventional deep cleaning. For example, thick spacer rings may be lapped into a specified dimension and thickness using grinding stones made of SiC materials. For disk drives, burnishing tapes made of Al₂O₃ may be used to clean contaminants off a disk's outer diameter area

Coating metal components reduces and possibly eliminates metal to metal contact that results during the manufacturing process thus reducing the generation of particles. Coating metal components reduces and possibly eliminates lapping of metal manufacturing tools thus reducing the generation of particles. For example, coating metal components reduces if not eliminates the exposure of metal burrs 240, generation of particles 230 and therefore reduces if not eliminates build up of particles 230 on metal tools over time.

### The Coated Metal Component and the Substance

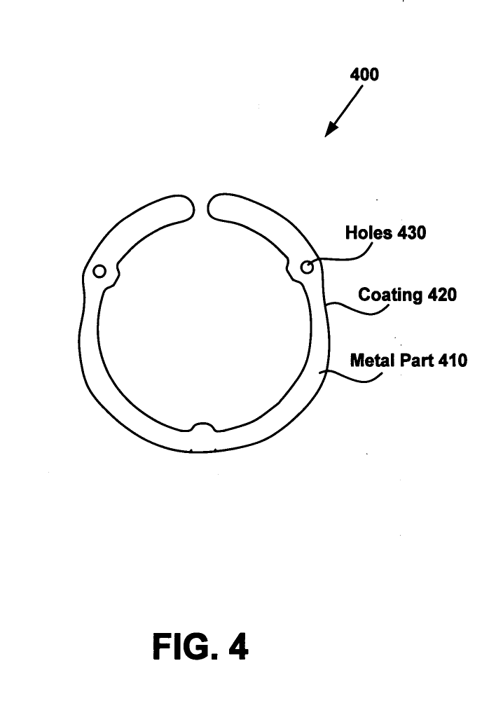

FIG. 4 depicts a coated metal component, according to one embodiment. The coated metal component 400, according is used to manufacture a hard disk drive. As depicted in FIG. 4, the coated metal component 400 includes a metal part 410 that could potentially result in generation of particles in the event that the metal part 410 comes into contact with other metal while manufacturing a hard disk drive. An uncoated conventional component, such as an uncoated balanced weight 220, is an example of a metal part 410, according to one embodiment. Examples of “other metal” include tools that include metal or components of the hard disk drive that include metal. The coated metal component also includes a coating 420 of substance around the metal part 410. The coating 420 of substance reduces the probability that the metal part 410 would come into contact with other metal during the manufacturing of the hard disk drive. Further, the coating 420 of substance eliminates lapping of the metal tools that would conventionally be performed as a part of deep cleaning.

### Coating of Substance

According to one embodiment, the coating 420 encapsulates the metal part 410 and provides lubrication between the metal part 410 and other metal. According to one embodiment, the substance is a type of polymer. The polymer according to one embodiment has a medium molecule width. The substance may include 10% 3M™ polymer epoxy. According to one embodiment, polymer may be dissolved in a solvent to create the substance that coats the metal part 410.

The coating 420 of substance can serve as a lubricant or as an encapsulator, or a combination thereof. For example, the coating 420 of substance can serve as a lubricant between two or more HDD components while they are being assembled together, can serve as a lubricant between an HDD component and a manufacturing tool or can serve as encapsulation of particles, such as burrs, that were on the metal part 410 before it 410 was coated with the substance. The metal part 410 may be coated before or after it is stamped.

### Experiments

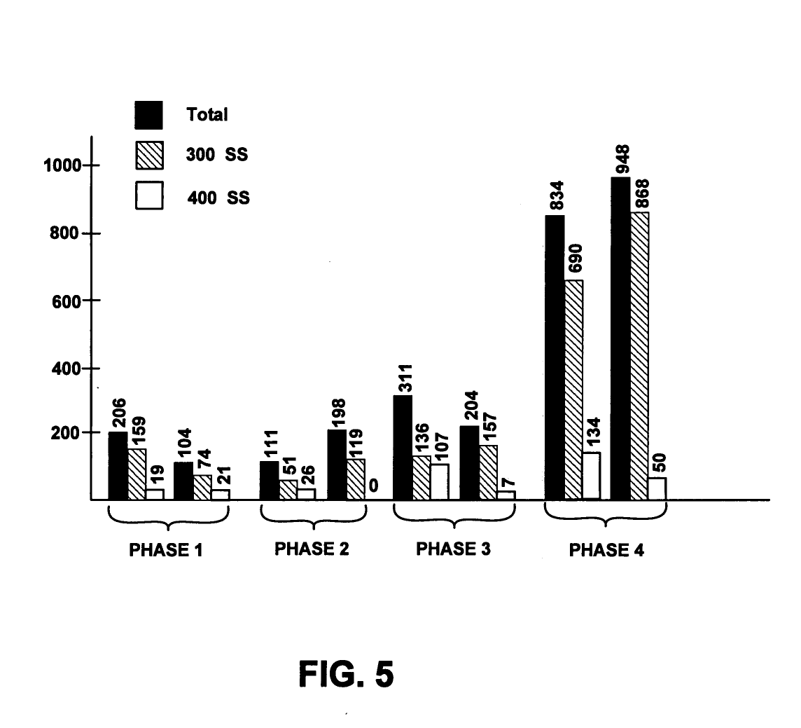

Experimentation was performed to determine what phases of a conventional manufacturing process resulted in the highest levels of particle generation. FIG. 5 depicts a bar chart of particles generated at various phases of a conventional manufacturing process using a conventional uncoated balanced weight, according to one embodiment. The experiment tested for the number of stainless steel 300 and stainless steel 400 particles. FIG. 5 depicts two samples for phases of the manufacturing process. Phase 1 tested for the number of particles that were on a disk pack without any part of the conventional manufacturing process being performed. Phase 2 tested for the number of particles that were generated due to a balanced weight being manually inserted onto a disk pack. Phase 3 tested for the number of particles that resulted due to opening a balanced weight as depicted in FIG. 3B and picking up a balanced weight as depicted in FIG. 3C using a C-hand. Phase 4 depicts the number of particles that resulted due to using a C-hand to open, pick up, and insert the balanced weight into a groove. Note that the number of particles generated during phase 4 is significantly higher than the number of particles generated for phases 1-3 indicating that the metal to metal contact that occurs during the conventional insertion process of an uncoated balanced weight results in the highest number of particles.

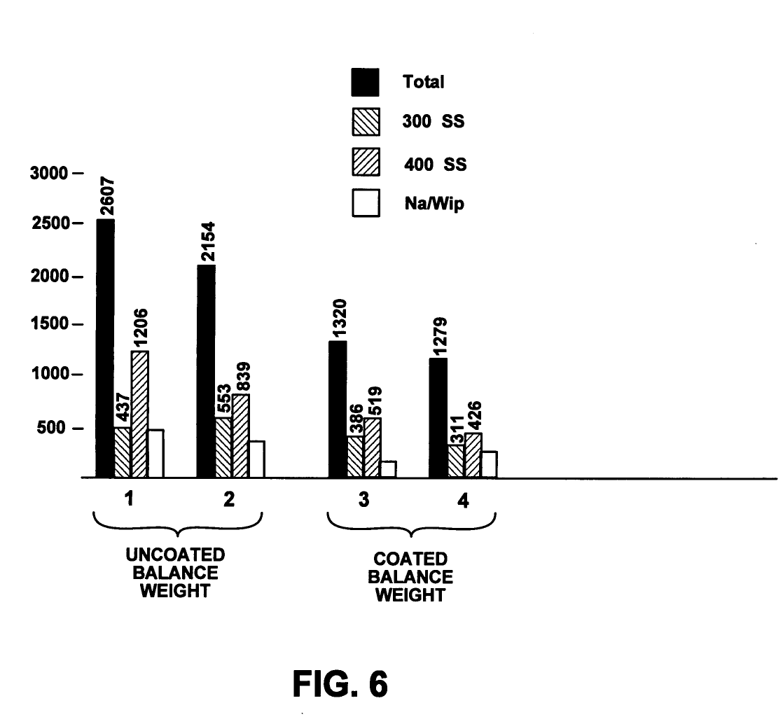

FIG. 6 depicts a bar chart comparing the number of particles generated using a conventional metal component and using a metal component that was coated using various embodiments. The conventional metal component was an uncoated balanced weight and the coated metal component was a coated balanced weight. As depicted in FIG. 6, the number of particles, which was a total respectively of 2607 and 2154 for samples s1 and s2, generated when using an uncoated balanced weight was significantly higher than the number of particles, which was a total respectively of 1300 and 1279 for samples s3 and s4, generated when using a coated balanced weight. Therefore, the bar chart clearly indicates that a coated metal component, according to various embodiments, significantly reduces the number of particles generated during the manufacturing process. For example, a coated metal component results in 20-40% reduction in the total number of particles generated.

There are specifications for components to ensure that the components will perform adequately. For example, there are specifications for the thickness and the measure of the balance of a balanced weight. The specification for thickness is 0.35 millimeters (mm) plus or minus 0.01 and the specification for imbalance is 0.42 mmg plus or minus 0.05. Experiments confirmed that a coated metal component, according to various embodiments, can conform to manufacturing specifications. For example, a balanced weight was tested for thickness, weight and imbalance before it was coated and after it was coated. The respective average, maximum and minimum thickness of the balanced weights prior to being coated were 0.349 mm, 0.349 mm, and 0.349 mm. The respective average, maximum, and minimum weight of the balanced weights prior to being coated were 0.534 grams (g), 0.536 g, and 0.532 g. The respective average, maximum, and minimum imbalance of the balanced weights prior to being coated were 0.438 mmg, 0.439 mmg, and 0.436 mmg. The respective average, maximum and minimum thickness of the balanced weights after being coated were 0.351 mm, 0.353 mm and 0.350 mm. The respective average, maximum, and minimum weight of the balanced weights after being coated were 0.535 g, 0.538 g and 0.532 g. The respective average, maximum, and minimum imbalance of the balanced weights after being coated were 0.447 mmg, 0.451 mmg and 0.440 mmg.

### A Method of Reducing Particle Generation as a Result of Metal to Metal Contact During the Manufacturing Process

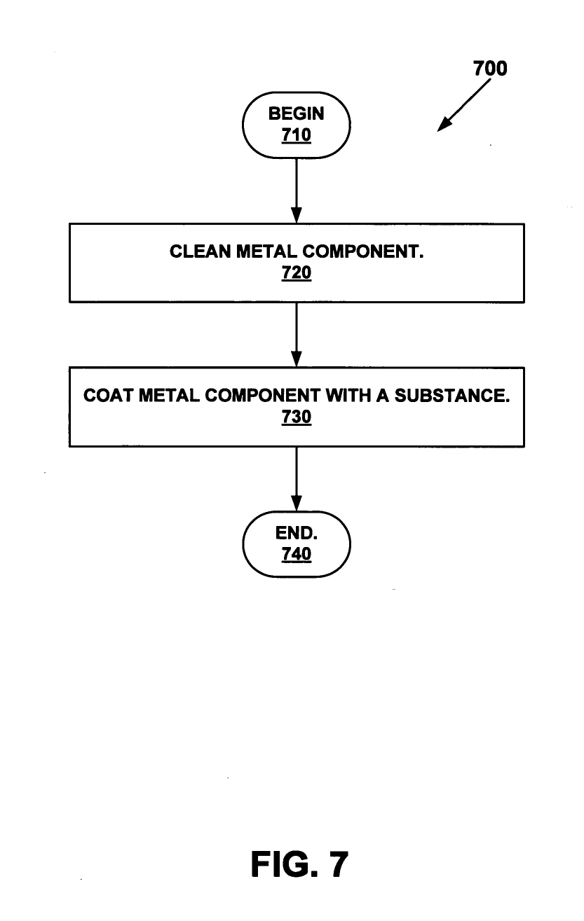

FIG. 7 depicts a flowchart of a method for reducing particle generation as a result of metal to metal contact during the manufacturing process, according to various embodiments. Although specific steps are disclosed in flowchart 700, such steps are exemplary. That is, embodiments of the present invention are well suited to performing various other steps or variations of the steps recited in flowchart 700. It is appreciated that the steps in flowchart 700 may be performed in an order different than presented, and that not all of the steps in flowchart 700 may be performed.

For the following illustration, assume that the metal component is a balanced weight.

In step 710, the method begins.

In step 720, the metal component is cleaned. For example, the metal part 410 can be cleaned using ultrasonic cleaning in di-ionized water or an organic solvent. The metal part 410 can be placed in a beaker of di-ionized water or organic solvent and put into an ultrasonic tank. The metal part 410 may be cleaned by a supplier of components for example using a mass washing process.

In step 730, the metal component is coated with a substance. For example, the metal component 400 has a coating 420 of substance to reduce the probability that that the metal part 410 of the metal component 400 will come into contact with other metal during the manufacturing of the hard disk drive. The substance 420 is coated on the metal component 400 to encapsulate the metal component 400 and to provide lubrication between the metal component 400 and other metal, which may come from other components or metal tools.

A polymer with a medium molecule width, such as 3M™ polymer epoxy, can be dissolved in a solution resulting in a substance that is approximately 10% 3M™ polymer epoxy. A metal part 410 can be dipped into the solution, which contains the dissolved polymer. The amount of substance that coats the metal part 410 can be controlled so that measurements of thickness and imbalance will conform to the specifications for the balanced weight, as described in the “Experiments” subheading. The amount of substance that coats the metal component can be controlled by the length of time it is dipped and the concentration of the polymer. The coating is dried. For example, the coating can be dried at a range of approximately 80 degrees Celsius (C) to 200 degrees C. According to one embodiment, the coating is dried at approximately 100 degrees Celsius. According to one embodiment, the coating is dried at a temperature that will cause cross linking of the substance's molecules. For example, the coating may be dried at approximately 120 degrees C.

By coating a metal component 400, the metal component 400 is encapsulated and lubricated to reduce the probability of metal to metal contact. Further, coating metal components significantly reduces and possibly even eliminates the halting of the manufacturing process that results from conventional cleaning of metal tooling which provides a significant financial savings to manufacturers of disk drives. There has been a long felt need for the significant financial savings that can be realized by reducing or eliminating conventional cleaning of metal tooling, among other things.

In step 740, the method ends.

The coated metal component can be used in manufacturing a hard disk drive. For example, a C-hand as depicted in FIGS. 3A-3E can be used to manipulate a coated balanced weight for the purpose of inserting it into a top clamp's groove.

What is claimed is:

1. A method of reducing particle generation as a result of metal to metal contact during the manufacturing process, the method comprising:
cleaning a metal component that will be used in manufacturing a hard disk drive; and
coating the metal component with a substance to reduce a probability that the metal component will come into contact with other metal during the manufacturing of the hard disk drive, wherein the coating of the substance encapsulates the metal component and provides lubrication between the metal component and the other metal.

2. The method as recited by claim 1, wherein the coating of the metal component with the substance further comprises:
coating the metal component with a polymer based substance.

3. The method as recited by claim 2, wherein the coating of the metal component with the polymer based substance further comprises:
coating the metal component with a polymer based substance that has medium molecule width.

4. The method as recited by claim 2, wherein the method further comprises:
dissolving polymer in a solution to create the polymer based substance.

5. The method as recited by claim 1, wherein the method further comprises:
controlling the thickness of the coating of substance on the metal component so that the thickness conforms to specifications for that particular type of metal tool.

6. The method as recited by claim 1, wherein:
the cleaning of the metal component further comprises cleaning a balanced weight; and
the coating of the metal component with the substance further comprises coating the balanced weight with the substance.

7. The method as recited by claim 1, wherein the method further comprises:
drying the coating substance on the metal component to cause cross linking of the substance's molecules.

8. A coated metal component that is used to manufacture a hard disk drive, the metal component comprising:
a metal part that potentially results in generation of particles in the event that the metal part comes into contact with other metal while manufacturing the hard disk drive; and
a coating of substance around the metal part to reduce a probability that the metal part will come into contact with the other metal during the manufacturing of the hard disk drive, wherein the coating of substance encapsulates the metal part and provides lubrication between the metal part and the other metal.

9. The coated metal component of claim 8, wherein the metal part is an uncoated balanced weight.

10. The coated metal component of claim 8, wherein the substance is a polymer based substance.

11. The coated metal component of claim 10, wherein the polymer based substance is approximately 10% 3M™ polymer epoxy.

12. The coated metal component of claim 8, wherein the substance is a polymer based substance that has medium molecule width.

13. The coated metal component of claim 8, wherein the coating of the substance was dried on the metal part at a temperature that ranged from approximately 80 Celsius to approximately 200 Celsius.

14. The coated metal component of claim 13, wherein the coating of the substance was dried on the metal part at a temperature that ranged from approximately 100 Celsius to 120 Celsius.

15. A hard disk drive that was manufactured with a metal component, the hard disk drive comprising:
a read write head for writing data to and reading data from a disk; and
a metal component with a coating of substance to reduce a probability that the metal component would come into contact with other metal during the manufacturing of the hard disk drive, wherein the coating of substance encapsulates a metal part of the metal component and provides lubrication between the metal part and the other metal.

16. The hard disk drive of claim 15, wherein the metal component is a balanced weight.

17. The hard disk drive of claim 15, wherein the substance is a polymer based substance.

18. The hard disk drive of claim 17, wherein the polymer based substance is approximately 10% 3M™ polymer epoxy.

19. The hard disk drive of claim 15, wherein the coating of the substance was dried on the metal component at a temperature that ranged from approximately 80 Celsius to approximately 200 Celsius.

20. The hard disk drive of claim 15, wherein the coating of the substance was dried on the metal component at a temperature that ranged from approximately 100 Celsius to 120 Celsius.
